(19) United States
(12) Patent Application Publication
(10) Pub. No.: US 2018/0247155 A1
(43) Pub. Date: Aug. 30, 2018

(54) IMAGE HISTOGRAM MAPPINGS

(71) Applicant: HP INDIGO B.V., Amstelveen (NL)

(72) Inventors: Liron Itan, Ness Ziona (IL); Oren Haik, Ness Ziona (IL)

(73) Assignee: HP INDIGO B.V., Amstelveen (NL)

(21) Appl. No.: 15/754,376

(22) PCT Filed: Sep. 3, 2015
(86) PCT No.: PCT/EP2015/070193

§ 371 Date: Feb. 22, 2018

(51) Int. Cl. G06K 9/62; G06K 9/46

(52) U.S. Cl. CPC G06K 9/6212; G06K 9/4642; G06K 9/4652

(57) ABSTRACT

An example system includes a histogram engine. The histogram engine is to generate a target histogram based on a target image. The example system also includes a dispersion engine to calculate a dispersion of the target histogram. The example system also includes a spreading engine to diffuse a reference histogram for a reference image based on the dispersion of the target histogram. The histogram engine also is to generate a mapping between the reference histogram with diffusion and the target histogram.

### BACKGROUND

An image may include a plurality of color channels. For example, the image may include red, green, and blue channels; magenta, yellow, cyan, and black channels; or the like. The color of each pixel in the image may be determined by the amount of each color channel included in that pixel. As used herein, the terms “intensity” and “gray level” refer to the amount of a particular color channel included in a pixel. The intensity may be quantized into a plurality of levels, such as the integers from zero to 255, a plurality of levels between zero and one, or the like. As used herein, the term “intensity level” refers to a quantized intensity. The color of a pixel may be represented by the quantized intensity level of each color channel for that pixel.

### BRIEF DESCRIPTION OF THE DRAWINGS

FIG. 1 is a block diagram of an example system to compare a target image to a reference image.

FIG. 2 is a block diagram of an environment containing an example system to compare a target image to a reference image.

FIG. 3 is a flow diagram of an example method to compare a target image to a reference image.

FIG. 4 is a flow diagram of another example method to compare a target image to a reference image.

FIG. 5 is a block diagram of an example computer-readable medium storing instructions to cause a processor to compare a target image to a reference image.

FIG. 6 is a block diagram of another example computer-readable medium storing instructions to cause a processor to compare a target image to a reference image.

### DETAILED DESCRIPTION

A user may want to compare images. In some examples, the user may know the images contain the same information (e.g., the same picture) except for changes in intensity that do not significantly change the information content of the image. The user may want to determine whether any differences in information are present in one of the images. For example, the user may want to ensure that the color of each pixel in a reference image matches the color of a corresponding location in a target image.

In an example, a printer may produce an image on a medium based on a reference image stored on a computer-readable medium. The printer may include a scanner to generate a copy of the printed image that can be stored on the computer-readable medium. The scanned image may be used as a target image to be compared to the reference image. The printer or an associated computer may compare the target image to the reference image to determine if there are any differences where the target image does not match the reference image. Alternatively, the target image may be compared to the reference image to calibrate printed colors and ensure color consistency. In an example, the printer may be two-dimensional printer (2D), and the scanner may be a 2D scanner. Alternatively, the printer may be a three-dimensional printer (3D), and the scanner may be a 3D scanner.

There may be changes to the color channel intensities of pixels in a target image relative to a reference image. For example, there may be systematic changes to the intensities. As used herein, the term “systematic changes” refers to differences in intensities between the target image and the reference image that are consistent for all pixels with the same color channel intensity. The size of the differences may vary depending on the particular color channel intensity level but may be consistent for all pixels with a same color channel intensity level. Systematic changes may not be considered differences in information content. There may also be nonsystematic changes to the color channel intensities that result in random dispersion of each color channel intensity to nearby intensity levels. As used herein, the term “dispersion” refers to the distributing of pixels from an intensity level to nearby intensity levels or a second or higher moment of a distribution resulting from such distributing. Pixels having a same color channel intensity may have their intensities dispersed to different nearby intensity levels. Minor nonsystematic changes may not be considered differences in information content.

Systematic changes may be accounted for by generating a mapping between intensity levels of the reference image and intensity levels of the target image. For example, for each color channel, a histogram may be generated for the reference image, and a histogram may be generated for the target image. Each histogram may indicate the number of pixels in the corresponding image that have each intensity level. Cumulative histograms for each image may be generated from each histogram. The cumulative histograms may indicate how many pixels in the corresponding image have an intensity level less than or equal to each intensity level. The mapping can be generated by determining for each reference image intensity level and corresponding cumulative histogram value the target image intensity level for which the target image cumulative histogram value is closest to the reference image cumulative histogram value or vice versa.

In an example, the reference image or the target image may be converted using the mapping and compared to the other image to detect differences. Accordingly, the mapping and conversion may reduce the number of false positives that result from the systematic changes when detecting differences. However, the mapping and conversion does not address the nonsystematic changes. The nonsystematic changes may still cause detection of false positives. In addition, the nonsystematic changes may prevent the mapping from properly mitigating the systematic changes and thus may cause false positives to result from the systematic changes. Similarly, the mapping may be used for color calibration to mitigate systematic changes to the color channels, but the nonsystematic changes may result in an incorrect calibration. Therefore, there is a need for a histogram mapping system that can mitigate mapping errors resulting from minor nonsystematic changes to a target image relative to a reference image.

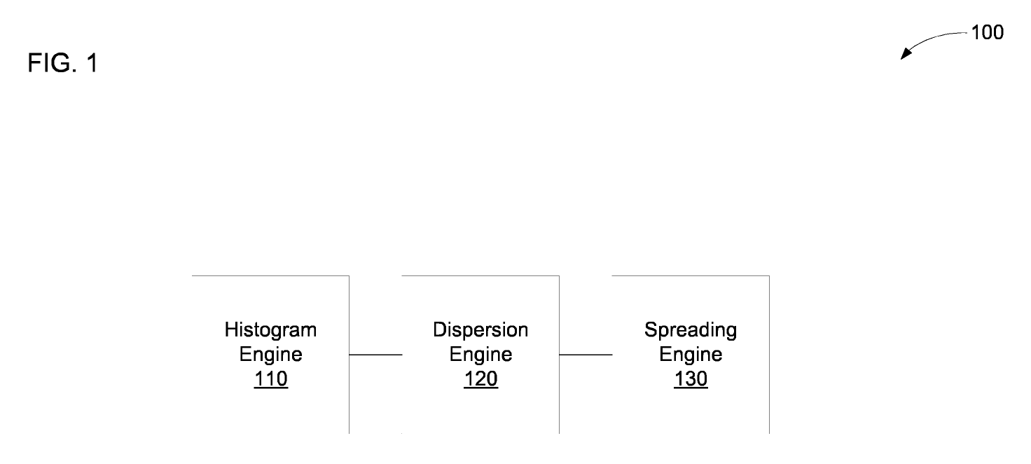

FIG. 1 is a block diagram of an example system 100 to compare a target image to a reference image. The system 100 may include a histogram engine 110. As used herein, the term “engine” refers to hardware (e.g., a processor, such as an integrated circuit, or analog or digital circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or executed or interpreted by a processor), or hardware and software hosted at hardware. The histogram engine 110 may generate a target histogram based on the target image. For example, the histogram engine 110 may determine an intensity for a pixel in the target image and may increment a histogram value corresponding to that intensity. The histogram engine 110 may iterate through every pixel in the target image determining the intensity and incrementing the corresponding histogram value to produce the histogram.

A dispersion engine 120 may determine a dispersion of the target histogram. In some examples, the dispersion engine 120 may calculate a local dispersion. The dispersion engine 120 may determine, for each intensity level, the dispersion of histogram values over the intensity level and nearby intensity levels. For example, the dispersion engine 120 may calculate the dispersion using a sliding window. The sliding window may increment by one intensity level or by a plurality of intensity levels. The dispersion engine 120 may calculate the dispersion as a variance, a standard deviation, a mean absolute deviation, or the like. The dispersion engine 120 may calculate the dispersion of histogram values, the dispersion of intensity levels weighted by histogram values, or the like.

A spreading engine 130 may diffuse a reference histogram corresponding to a reference image based on the dispersion of the target histogram. As used herein, the term “diffusing” refers to any operation that reduces the difference between at least two histogram values. For example, the spreading engine 130 may diffuse the reference histogram by spreading a portion of a histogram value associated with a particular intensity level into nearby intensity levels. The amount of each histogram value spread, the number of nearby intensity levels into which it is spread, or the distribution of spreading may be determined based on the dispersion (e.g., a local dispersion in a corresponding portion of the target histogram). For example, the spreading engine 130 may diffuse the reference histogram more at locations where the corresponding local dispersion in the target histogram is larger.

The histogram engine 110 may generate a mapping between the reference histogram with diffusion and the target histogram. For example, the mapping may indicate target histogram intensity levels corresponding to each reference histogram intensity level or vice versa. The mapping may be used to compare images, to calibrate colors, or the like.

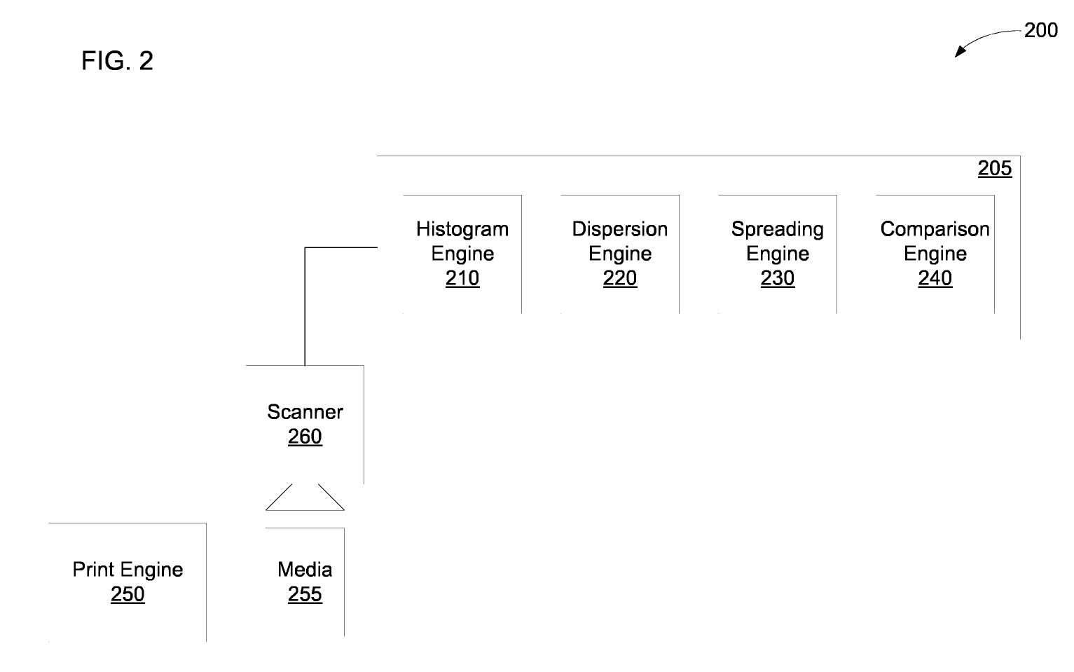

FIG. 2 is a block diagram of an environment 200 containing an example system 205 to compare a target image to a reference image. The environment 200 may include a scanner 260. The scanner 260 may capture an image of a printed image formed on media 255 by a print engine 250. For example, the target image may be an image captured by the scanner 260 and provided to the system 205. In the illustrated example, the system 205 does not include the print engine 250 or the scanner 260. In other examples, the system 205 may include the print engine 250 or the scanner 260.

The system 205 may include a histogram engine 210. The histogram engine 210 may generate a target histogram based on the target image. The histogram engine 210 may also generate a reference histogram based on a reference image. Alternatively, the reference histogram may have been previously generated. The reference image may have been used to form the printed image. In some examples, the print engine 250 may perform predetermined modifications (e.g., modifications specified by an operator) to the reference image prior to printing. The target image or reference image may be adjusted to correct for these modifications prior to generating the corresponding histogram. The histogram engine 210 may generate a mapping between the reference histogram and the target histogram. The mapping may be a two-way mapping that generates reference histogram intensities when target histogram intensities are input or generates target histogram intensities when reference histogram intensities are input. Alternatively, the mapping may be a one-way mapping that only generates reference histogram intensities from target histogram intensities or that only generates target histogram intensities from reference histogram intensities.

The histogram engine 210 may generate the mapping by generating an initial mapping between the reference histogram and the target histogram. The histogram engine 210 may then generate a final mapping between the reference histogram and the target histogram. The initial mapping may be between elements in a predetermined set of values. For example, the initial mapping may map quantized intensity levels in the reference histogram to quantized intensity levels in the target histogram or vice versa. The final mapping may include values outside the predetermined set of values. For example, the intensities in the final mapping may include interstitial values between the quantized intensity levels. The intensities in the final mapping for both the reference histogram and the target histogram may include interstitial values or intensities for one of the reference histogram and the target histogram may include interstitial values.

In an example, the histogram engine 210 may determine an interstitial value in a target histogram to correspond to a particular reference histogram intensity level in the final mapping. First, the histogram engine 210 may determine a target histogram intensity level corresponding to the particular reference histogram intensity level in the initial mapping. The histogram engine 210 may select a neighboring target histogram intensity level based on a comparison of a reference cumulative histogram value at the particular reference histogram intensity level with a target cumulative histogram value at the target intensity level. If the reference cumulative histogram value is larger, the histogram engine 210 may select the next intensity level larger than the target histogram intensity level. If the reference cumulative histogram value is smaller, the histogram engine 210 may select the next intensity level smaller than the target histogram intensity level. If the cumulative histogram values are equal, the reference histogram intensity level may be mapped to the target histogram intensity level rather than selecting an interstitial value.

The histogram engine 210 may draw a line mathematically between the neighboring target histogram intensity levels. As used herein, the term “mathematically” performing a geometric operation refers to performing a computation that produces a result equivalent to the geometric operation. The histogram engine 210 may determine mathematically a point on the line where the target cumulative histogram value equals the reference cumulative histogram value for the particular reference histogram intensity level. The distance along the line in the intensity direction may be added to the target histogram intensity level from the initial mapping to produce an interstitial intensity for the final mapping.

For example, if intensity levels are defined to be an x-axis and cumulative histogram values are defined to be a y-axis, the slope of the line connecting neighboring target histogram intensity levels may be computed as Δy/Δx, where Δy and Δx are computed based on the target histogram intensity level and the neighboring target histogram intensity level. As used herein, the symbol “Δ” refers to the change in the variable it precedes. The distance along the line in the intensity direction may be computed as Δy/slope, where Δy is the difference between the reference cumulative histogram value for the particular reference histogram intensity level and the target cumulative histogram value for the target histogram intensity level corresponding to the particular reference histogram intensity level in the initial mapping. Thus, in one example, the histogram engine 210 may compute a final mapping from a particular reference histogram intensity level i to a target histogram intensity M_{f}(i) according to the equation:

$${M}_{f} ( i ) = {M}_{i} ( i ) + \frac{( C H R ( i ) - C H T ( {M}_{i} ( i ) ) ) * d}{C H T ( {M}_{i} ( i ) + d ) - C H T ( {M}_{i} ( i ) )} \qquad ( 1 )$$

Where Mᵢ(i) is the target histogram intensity level corresponding to the particular reference histogram intensity level i according to the initial mapping, CHR(i) is the cumulative reference histogram value at the particular reference histogram intensity level i, CHT(Mᵢ(i)) is the cumulative target histogram value at the target histogram intensity level Mᵢ(i), and d is the difference in intensity between the neighboring target histogram intensity level and the target histogram intensity level Mᵢ(i) and is negative if the neighboring target histogram intensity level is less than the target histogram intensity level Mᵢ(i). The histogram engine 210 may determine an interstitial value in the reference histogram to be mapped to a particular target histogram intensity level in a similar manner.

The system 205 may include a dispersion engine 220. The dispersion engine 220 may generate an estimated target histogram based on the reference histogram and the mapping. For example, the dispersion engine 220 may create the estimated target histogram by starting with an empty histogram and adding the reference histogram value for each reference histogram intensity level to a target histogram intensity level indicated by the mapping. If the mapping includes interstitial reference histogram intensities or interstitial target histogram intensities, the dispersion engine 220 may split reference histogram values among estimated target histogram values according to the interstitial values. For example, if a reference histogram intensity level maps to an intensity one-fourth of the way between a first target histogram intensity level and a second target histogram intensity level, three-fourths of the reference histogram value may be added to the estimated target histogram value corresponding to the closer target histogram intensity level.

In one example, target histogram intensity levels may be mapped to interstitial reference histogram intensities. The dispersion engine 220 may compute a start point by averaging a reference intensity corresponding to a particular target intensity level with a reference intensity corresponding to a next smaller target intensity level. The dispersion engine 220 may compute an end point by averaging the reference intensity corresponding to the particular target intensity level with a reference intensity corresponding to a next larger target intensity level. The dispersion engine may compute an estimated target histogram value for the particular target intensity level by adding all reference histogram values between the start point and the end point and portions of the reference histogram values above and below the start and end points respectively. The portions of the reference histogram values above and below the start and end points respectively to be added may be determined based on the proximity of the start and end points to the above and below reference histogram intensity levels. For example, if the end point is one-fourth of the way between a reference intensity level just below the end point and the next reference intensity level larger than the end point, one-fourth of the reference histogram value corresponding to the next reference intensity level larger than the end point may be added to the estimated target histogram value.

The dispersion engine 220 may calculate a dispersion of the target histogram. In one example, the dispersion engine 220 may calculate an overall dispersion of the entire target histogram. Alternatively, or in addition, the dispersion engine 220 may calculate local dispersions at different locations in the target histogram, for example, using a sliding window. The dispersion engine 220 may calculate a relative dispersion of the target histogram relative to the estimated target histogram. For example, the dispersion engine 220 may calculate the local dispersions of the estimated target histogram in addition to the local dispersions of the target histogram and may compute relative local dispersions as the ratio, difference, or the like between the local dispersions. In one example, the relative dispersions may be computed by calculating the local dispersions of the reference histogram and relating the local dispersions using the mapping rather than generating the estimated target histogram. The dispersion engine 220 may quantize the relative dispersions, for example, by rounding each relative dispersion to a nearest integer.

The system 205 may include a spreading engine 230. The spreading engine 230 may diffuse the reference histogram based on the dispersion of the target histogram. For example, the spreading engine 230 may diffuse the reference histogram locally based on the relative local dispersions computed from the target histogram and the estimated target histogram. The spreading engine 230 may use the mapping to determine how much to diffuse each location in the reference histogram. For example, the mapping may be used to convert relative local dispersions for target histogram intensity levels to relative local dispersions for reference histogram intensity levels.

The spreading engine 230 may diffuse the reference histogram by convolving it with a plurality of diffusion filters. The plurality of diffusion filters may include a plurality of Gaussian filters in one example. The amount of diffusion of each filter may be determined by a corresponding relative local dispersion (e.g., a corresponding quantized relative local dispersion). The spreading engine 230 may apply a plurality of masks to the reference histogram based on the relative local dispersions. There may be one mask for each different relative local dispersion value. Quantizing the relative local dispersions may reduce the number of masks. Each diffusion filter may be convolved with a corresponding masked version of the reference histogram. The resultant filtered, masked histograms may be added together to create the diffused reference histogram.

The convolution operations may create elements outside the domain of the reference histogram. As used herein, the term “domain” refers intensities for which a histogram or an image is defined. For example, portions of the reference histogram value corresponding to the largest possible intensity level may be diffused to intensity levels above the largest possible intensity level. The print engine 250 or a display device may be unable to render intensity levels above the largest possible intensity level. The elements outside the domain of the reference histogram may be added to elements inside the domain so the domain of the reference histogram does not change due to the convolution operations. For example, the portions diffused above the largest possible intensity level may be added to the largest possible intensity level or to intensity levels near and less than the largest possible intensity level.

The histogram engine 210 may determine an updated mapping between the diffused reference histogram and the target histogram. In an example, the updated mapping does not include interstitial intensities. In some examples, additional iterations of diffusing the reference histogram may be performed. For example, the dispersion engine 220 may update the estimated target histogram based on the diffused reference histogram and the updated mapping. The dispersion engine 220 may generate the updated estimated target histogram in the same way it generated the estimated target histogram but using the diffused reference histogram and updated mapping instead of the reference histogram and mapping. The dispersion engine 220 may update the relative dispersion of the target histogram based on the updated estimated target histogram. The dispersion engine 220 may generate the updated relative dispersion in the same way it generated the relative dispersion but using the updated estimated target histogram rather than the estimated target histogram.

The spreading engine 230 may update the diffused reference histogram based on the updated relative dispersion. The spreading engine 230 may generate the updated diffused reference histogram in the same way it generated the diffused reference histogram but using the updated relative dispersion and the diffused reference histogram rather than the relative dispersion and the reference histogram. In another example, the dispersion engine 220 may generate the updated estimated target histogram based on the reference histogram and the updated mapping, and the spreading engine 230 may generate the updated diffused reference histogram based on the reference histogram and the updated relative dispersion. The histogram engine 210 may again determine an updated mapping but do so based on the updated diffused reference histogram rather than the diffused reference histogram. The system 205 may perform a predetermined number of iterations, may perform iterations until the diffused reference histogram or the updated mapping converges (e.g., the change between iterations in the diffused reference histogram or the updated mapping is less than a predetermined threshold), or the like.

The system 205 may include a comparison engine 240. The comparison engine 240 may determine whether the target image matches the reference image based on the updated mapping. For example, the comparison engine 240 may generate an estimated target image based on the updated mapping. As previously discussed, the updated mapping may be generated from the target histogram and the diffused reference histogram. The diffused reference histogram may account for minor nonsystematic changes that may have occurred to the target image. Accordingly, the updated mapping may be used to compare the reference image to the target image with fewer detections of false positives arising from nonsystematic changes. The comparison engine 240 may use the updated mapping generated after a single iteration or the updated mapping generated after several iterations of updating the diffused reference histogram.

The histogram engine 210, the dispersion engine 220, and the spreading engine 230 may generate an updated mapping for each color channel. The comparison engine 240 may generate the estimated target image by converting the intensity of each color channel of each pixel of the reference image to a target image intensity using the updated mapping. The comparison engine 240 may compare the estimated target image to the target image to detect differences in the target image from the reference image. For example, the comparison engine 240 may calculate a peak signal-to-noise ratio, a mean square error, a structural similarity index, or the like to detect differences. Alternatively, or in addition, the comparison engine 240 may generate an estimated reference image from the target image and the updated mapping and compare the estimated reference image to the reference image. The comparison engine 240 may indicate any differences detected to a user. In an example, a color calibration of the print engine 250 may be adjusted based on the updated mapping in addition to or instead of detecting differences.

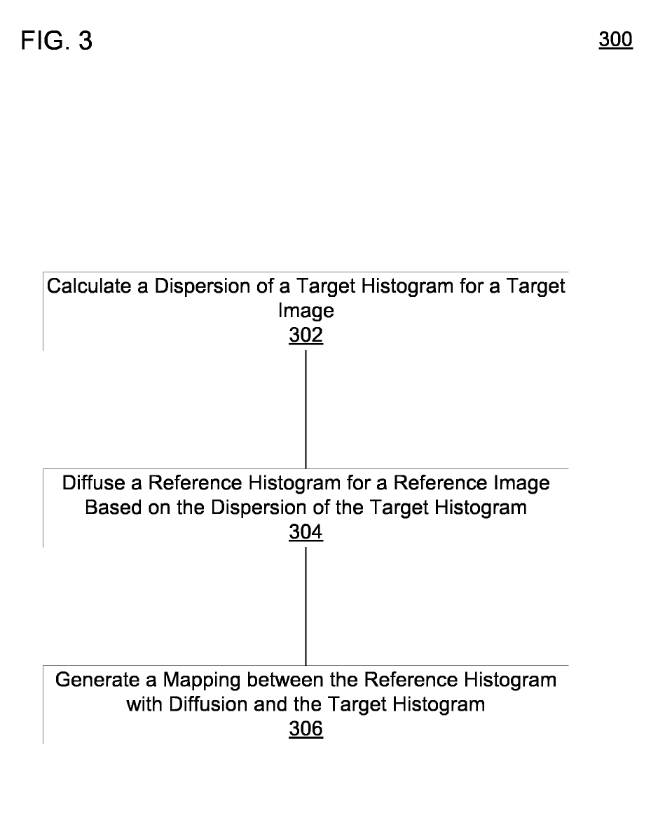

FIG. 3 is a flow diagram of an example method 300 to compare a target image to a reference image. The method 300 may be performed by a processor. At block 302, the method 300 may include calculating a dispersion of a target histogram for a target image. The dispersion may be the dispersion of target histogram values, the dispersion of intensity levels weighted by the target histogram values, or the like. The dispersion may be a global dispersion, a local dispersion, an absolute dispersion, a relative dispersion, or the like. Referring to FIG. 1, the dispersion engine 120 may calculate the dispersion in an example.

Block 304 may include diffusing a reference histogram for a reference image based on the dispersion of the target histogram. For example, the reference histogram may be diffused so that it has a dispersion similar to that of the target histogram. Diffusing the reference histogram may include spreading portions of a histogram value associated with an intensity level to neighboring intensity levels. The amount of the histogram spread, the number of neighboring intensity levels spread to, or the distribution of the spreading may be determined based on the dispersion of the target histogram. In an example, the spreading engine 130 of FIG. 1 may diffuse the reference histogram.

At block 306, the method 300 may include generating a mapping between the reference histogram with diffusion and the target histogram. The mapping may indicate target histogram intensities corresponding to each reference histogram intensity level or vice versa. The mapping may include interstitial intensities of the reference histogram or the target histogram or may be between intensity levels for each histogram. The mapping may be usable to compare the target image to the reference image, adjust a color calibration used to produce the target image, or the like. The histogram engine 110 of FIG. 1 may generate the mapping between the reference histogram with diffusion and the target histogram in an example.

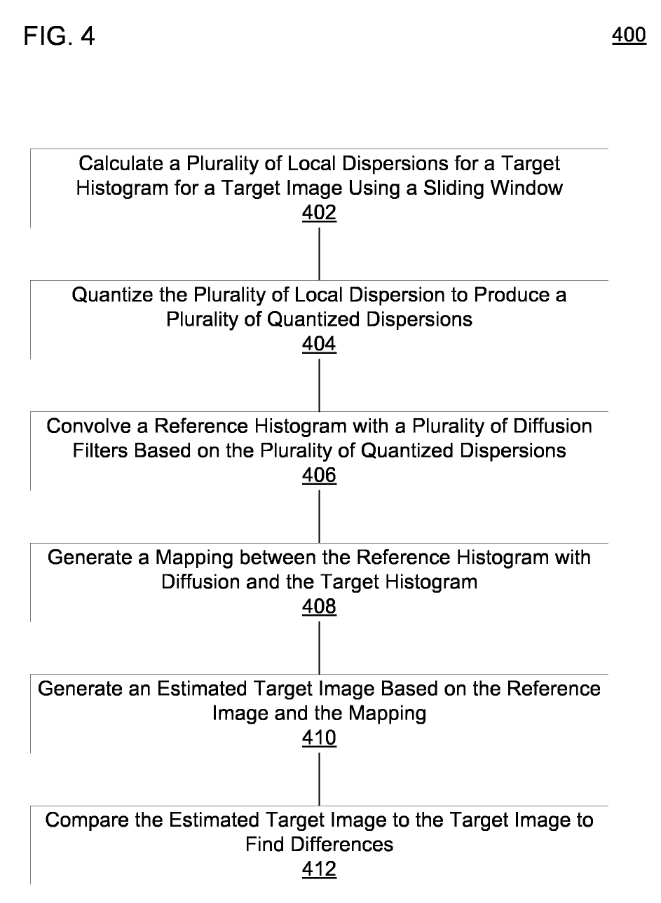

FIG. 4 is a flow diagram of another example method 400 to compare a target image to a reference image. At block 402, the method 400 may include calculating a plurality of local dispersions for a target histogram of a target image using a sliding window. The sliding window may be used to calculate the dispersion over a portion of the histogram. In an example, the sliding window may be incremented by one intensity level after each calculation. The local dispersion may be a variance, a standard deviation, a mean absolute deviation, or the like. The plurality of local dispersions may be a plurality of relative dispersions that relate dispersion of the target histogram to that of a reference histogram (or an estimated target histogram generated from the reference histogram). For example, the plurality of relative dispersions may be computed as ratios, differences, or the like between target histogram dispersions and reference histogram dispersions (or estimated target histogram dispersions) or vice versa. In an example, a single, global dispersion may be computed for the target histogram. The global dispersion may be a relative dispersion between target histogram and the reference histogram or estimated target histogram.

Block 404 may include quantizing the plurality of local dispersions to produce a plurality of quantized dispersions. The dispersions may be quantized to a nearest integer, to a nearest fraction of an integer, or the like. In an example, the plurality of local dispersions may be ratios between target histogram dispersions and reference histogram dispersions, and the ratios may be quantized to the nearest integer. Referring to FIG. 2, the dispersion engine 220, for example, may calculate the plurality of local dispersions and quantize the plurality of local dispersions.

Block 406 may include convolving a reference histogram with a plurality of diffusion filters based on the plurality of quantized dispersions. For example, there may be a diffusion filter for each different value in the plurality of quantized dispersions. The amount of diffusion applied by each diffusion filter may depend on the corresponding quantized dispersion. In an example, the diffusion filters may be Gaussian functions, and the standard deviation of the Gaussian functions may be proportional to the quantized dispersions. The reference histogram may be divided into a plurality of portions corresponding to each different value in the plurality of quantized dispersions. A mapping may be used to determine which portions of the reference histogram correspond to which relative dispersion of the target histogram. The portions may be non-contiguous. Each portion may be convolved with the corresponding diffusion filter. The plurality of portions may be reassembled after convolving, for example, by summing the portions. The convolving may create histogram values outside the domain of intensity levels for the reference histogram, so the histogram values outside the domain may be added to histogram values inside the domain. In an example where a global dispersion is calculated, a single diffusion filter may be used. In an example, the spreading engine 230 of FIG. 2 may convolve the reference histogram with the plurality of diffusion filters.

At block 408, the method 400 may include generating a mapping between the reference histogram with diffusion and the target histogram. The mapping may be between reference histogram intensity levels and target histogram intensity levels or may include interstitial intensities. The mapping may be generated by minimizing a distance between cumulative histogram values. For example, a particular reference histogram intensity level may be mapped to a target histogram intensity level for which the cumulative target histogram value corresponding to the target histogram intensity level is nearest the cumulative diffused reference histogram value corresponding to the particular reference histogram intensity level. The histogram engine 210 of FIG. 2 may generate the mapping in an example. In some examples, blocks 402 through 408 may be repeated a predetermined number of times or until the reference histogram with diffusion or the mapping converges to a fixed set of values.

At block 410, the method 400 may include generating an estimated target image based on the reference image and the mapping. The estimated target image may be generated by, for each pixel, determining a corresponding reference image pixel and adjusting that pixel based on the mapping. For example, the intensity of each pixel in the reference image may be converted to an intensity specified by the mapping to produce a corresponding pixel in the estimated target image. There may be a mapping for each color channel in the reference image or target image, and the intensity of each color channel of each pixel may be converted according to a mapping for that color channel.

Block 412 may include comparing the estimated target image to the target image to find differences between the target image and the estimated target image. A statistical test (e.g., a peak signal-to-noise ratio, a mean square error, a structural similarity index, etc.) may be used to determine if the difference between the estimated target image and the target image is more than a predetermined threshold or if the difference between an area in each image is more than a predetermined threshold. If the statistical test indicates a difference above the predetermined threshold, a difference may be detected. Alternatively, the statistical test may determine a similarity between the images or portions of the images, and a similarity less than a predetermined threshold may be detected as a difference. In an example, the comparison engine 240 of FIG. 2 may generate the estimated target image and compare the estimated target image to the target image.

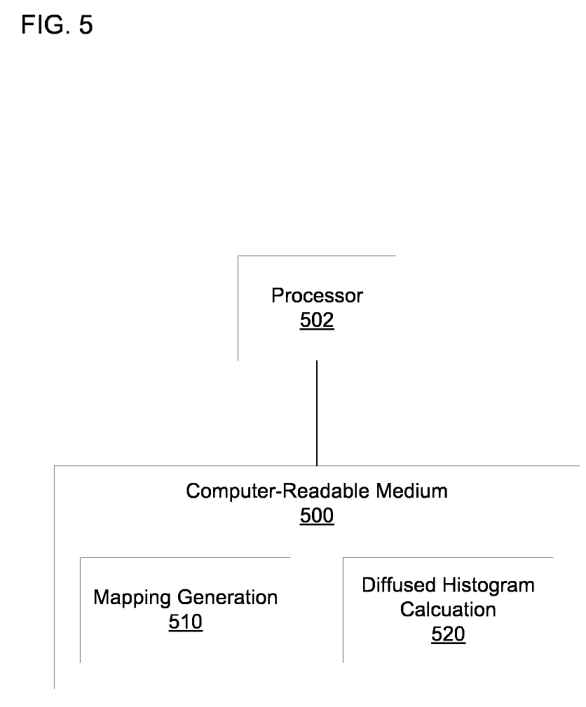

FIG. 5 is a block diagram of an example computer-readable medium 500 storing instructions that, when executed by a processor 502, cause the processor 502 to compare a target image to a reference image. The computer-readable medium 500 may be a non-transitory computer readable medium, such as a volatile computer readable medium (e.g., volatile RAM, a processor cache, a processor register, etc.), a non-volatile computer readable medium (e.g., a magnetic storage device, an optical storage device, a paper storage device, flash memory, read-only memory, non-volatile RAM, etc.), and/or the like. The processor 502 may be a general purpose processor or special purpose logic, such as a microprocessor, a digital signal processor, a microcontroller, an ASIC, an FPGA, a programmable array logic (PAL), a programmable logic array (PLA), a programmable logic device (PLD), etc.

The computer-readable medium 500 may include a mapping generation module 510 and a diffused histogram calculation module 520. As used herein, a “module” (in some examples referred to as a “software module”) is a set of instructions that when executed or interpreted by a processor or stored at a processor-readable medium realizes a component or performs a method. The mapping generation module 510 may cause the processor 502 to generate a first mapping between a reference histogram for a reference image and a target histogram for a target image. The mapping generation module 510 may cause the processor 502 to generate the first mapping by minimizing the difference between cumulative histogram values corresponding to intensity levels being mapped to each other. Referring to FIG. 1, the mapping generation module 510, when executed by the processor 502, may realize, for example, the histogram engine 110.

The diffused histogram calculation module 520 may cause the processor 502 to calculate a first diffused reference histogram based on the target histogram and the mapping. For example, the diffused histogram calculation module 520 may cause the processor 502 to determine how much to diffuse each location in the reference histogram based on characteristics of a corresponding location in the target histogram. The diffused histogram calculation module 520 may cause the processor 502 to determine the corresponding location in the target histogram based on the mapping. In an example, the diffused histogram calculation module 520, when executed by the processor 502, may realize the dispersion engine 120 or the spreading engine 130 of FIG. 1.

The mapping generation module 510 may cause the processor 502 to generate a second mapping between the first diffused reference histogram and the target histogram. For example, the mapping generation module 510 may cause the processor 502 to generate the second mapping in the same manner it generated the first but based on the first diffused reference histogram rather than the reference histogram. The diffused histogram calculation module 520 may cause the processor 502 to calculate a second diffused reference histogram based on the target histogram and the second mapping. For example, the diffused histogram calculation module 520 may cause the processor 502 to calculate the second diffused reference histogram in the same manner it calculated the first diffused reference histogram but based on the second mapping rather than the first mapping.

The mapping generation module 510 may cause the processor 502 to generate a third mapping between the second diffused reference histogram and the target histogram. For example, the mapping generation module 510 may cause the processor 502 to generate the third mapping in the same manner it generated the first and second mappings but based on the second diffused reference histogram rather than the reference histogram or the first diffused reference histogram. The third mapping may be used to compare the reference and target images, to perform color calibration, or the like.

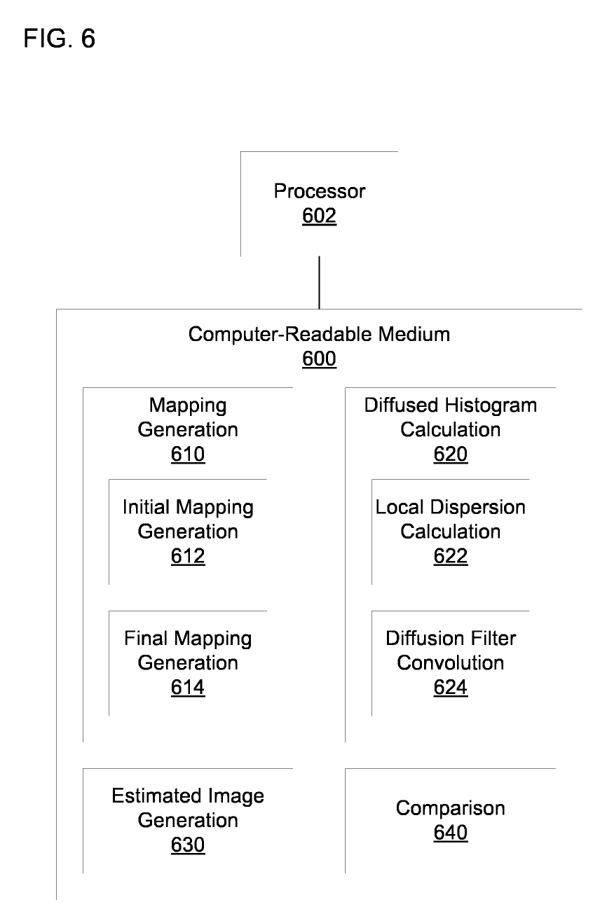

FIG. 6 is a block diagram of another example computer-readable medium 600 storing instructions that, when executed by a processor 602, cause the processor 602 to compare a target image to a reference image. The computer-readable medium 600 may include a mapping generation module 610. The mapping generation module 610 may include an initial mapping generation module 612 and a final mapping generation module 614. The initial mapping generation module 612 may cause the processor 602 to generate a mapping between reference histogram intensity levels and target histogram intensity levels, for example, by minimizing the difference between corresponding cumulative histogram values. The final mapping generation module 614 may cause the processor 602 to generate a mapping between intensity levels in one of the reference histogram and the target histogram and interstitial intensities in the other of the reference histogram and the target histogram. In an example, the final mapping generation module 614 may cause the processor 602 to generate the final mapping in a manner similar to equation (1). Referring to FIG. 2, the mapping generation module 610, when executed by the processor 602, may realize, for example, the histogram engine 210.

The computer-readable medium 600 may include a diffused histogram calculation module 620. The diffused histogram calculation module 620 may include a local dispersion calculation module 622 and a diffusion filter convolution module 624. The local dispersion calculation module 622 may cause the processor 602 generate an estimated target histogram based on the reference histogram and the first mapping. For example, the local dispersion calculation module 622 may cause the processor 602 to determine an estimated target histogram value based on the corresponding reference histogram values indicated by the mapping. The local dispersion calculation module 622 may cause the processor 620 to determine a plurality of local dispersions of the target histogram relative to the estimated target histogram. For example, the local dispersion calculation module 622 may cause the processor 602 to calculate local dispersions of the target histogram and the estimated target histogram using sliding windows and to calculate a plurality of relative dispersions as a ratio, difference, etc. between the estimated target histogram local dispersions and the target histogram local dispersions or vice versa.

The diffusion filter convolution module 624 may cause the processor 602 to calculate a diffused reference histogram based on the plurality of local dispersions. The diffusion filter convolution module 624 may cause the processor 602 to calculate the diffused reference histogram by convolving the reference histogram with a diffusion filter. The diffusion filter convolution module 624 may cause the processor 602 to add elements that end up outside a domain of the reference histogram to elements inside the domain, so the domain of the reference histogram and the diffused reference histogram are the same. The diffusion filter convolution module 624 may cause the processor 602 to determine a diffusion filter for each local dispersion and to convolve each diffusion filter with a corresponding portion of the reference histogram. For example, the diffusion filter convolution module 624 may cause the processor 602 to determine the corresponding portion of the reference histogram for each local dispersion by using the mapping to convert an intensity level in the sliding window used to calculate the local dispersion to a reference histogram intensity level. Reference histogram intensity levels with a same local dispersion may be included in a same portion. The local dispersion calculation module 622 may cause the processor 602 to quantize the plurality of local dispersions to reduce the number of portions. The diffusion filter convolution module 624 may cause the processor 602 to combine the portions after convolution with the diffusion filters to form the diffused reference histogram. In an example, the local dispersion calculation module 622, when executed by the processor 602, may realize the dispersion engine 220 of FIG. 2, and the diffusion filter convolution module 624, when executed by the processor 602, may realize the spreading engine 230.

The mapping generation module 610 and the diffused histogram calculation module 620 may cause the processor 602 to generate mappings and calculate diffused reference histograms repeatedly using the mappings or diffused reference histograms from previous rounds. The mapping generation module 610 and the diffused histogram calculation module 620 may cause the processor 602 to repeat a predetermined number of times, until the mappings or the diffused reference histograms converge, or the like. The mapping generation module 610 may cause the processor 602 to generate a last mapping after the repetitions are complete. In an example, the mapping generation module 610 may cause the processor 602 to generate the last mapping as a mapping that does not include interstitial intensities. The mapping generation module 610 and the diffused histogram calculation module 620 may cause the processor 602 to generate mappings for each color channel of the reference image or the target image (e.g., red, green, and blue color channels; cyan, magenta, yellow, and black color channels; or the like).

The computer-readable medium 600 may include an estimated image generation module 630. The estimated image generation module 630 may cause the processor 602 to generate an estimated target image from the last mapping and the reference image. For example, the estimated image generation module 630 may cause the processor 602 to determine the intensities of each color channel of each pixel in the estimated target image by applying the last mapping to an intensity of a corresponding color channel of a corresponding pixel in the reference image. The computer-readable medium 600 may include a comparison module 640. The comparison module 640 may cause the processor 602 to compare the estimated target image to the target image to find differences between the target image and the estimated target image. For example, the comparison module 640 may cause the processor 602 to apply a statistical test (e.g., a peak signal-to-noise ratio, a mean squared error, a structural similarity index, etc.) to determine differences (or similarities) between the estimated target image and the target image. If the differences are above a predetermined threshold (or similarities below a predetermined threshold), the comparison module 640 may cause the processor 602 to detect a difference. The comparison module 640 may cause the processor 602 to detect differences locally or only detect whether the images are globally different. The estimated image generation module 630 or the comparison module 640, when executed by the processor 602, may realize, for example, the comparison engine 240 of FIG. 2.

The above description is illustrative of various principles and implementations of the present disclosure. Numerous variations and modifications will become apparent to those skilled in the art once the above disclosure is fully appreciated. Accordingly, the scope of the present application should be determined only by the following claims.

What is claimed is:

1. A system, comprising:
a histogram engine to generate a target histogram based on a target image;
a dispersion engine to calculate a dispersion of the target histogram; and
a spreading engine to diffuse a reference histogram for a reference image based on the dispersion of the target histogram,
wherein the histogram engine is to generate a mapping between the reference histogram with diffusion and the target histogram.

2. The system of claim 1, wherein the histogram engine is to generate a mapping between the reference histogram and the target histogram prior to calculation of the dispersion, and wherein the dispersion engine is to generate an estimated target histogram from the reference histogram and the mapping and to calculate a relative dispersion based on a local dispersion of the target histogram and a local dispersion of the estimated target histogram.

3. The system of claim 2, wherein the spreading engine is to determine how much to diffuse a location in the reference histogram based on the relative dispersion between the target histogram and the estimated target histogram and the mapping.

4. The system of claim 2, wherein the dispersion engine is to update the relative dispersion based on the reference histogram with diffusion, wherein the spreading engine is to update the reference histogram with diffusion based on the relative dispersion after updating, wherein the histogram engine is to generate a mapping between the reference histogram with diffusion after updating and the target histogram, and wherein the system further comprises a comparison engine to determine whether the target image matches the reference image based on the mapping between the reference histogram with diffusion after updating and the target histogram.

5. The system of claim 2, wherein the histogram engine is to generate the mapping between the reference histogram and the target histogram by generating an initial mapping between the reference histogram and the target histogram and generating a final mapping between the reference histogram and the target histogram, wherein the initial mapping is between elements in a predetermined set of values, and wherein the final mapping includes values other than the predetermined set of values.

6. A method, comprising:
calculating, using a processor, a dispersion of a target histogram for a target image;
diffusing, using the processor, a reference histogram for a reference image based on the dispersion of the target histogram;
generating, using the processor, a mapping between the reference histogram with diffusion and the target histogram.

7. The method of claim 6, wherein calculating the dispersion comprises calculating a plurality of local dispersions using a sliding window.

8. The method of claim 7, wherein diffusing the reference histogram comprises convolving the reference histogram with a plurality of diffusion filters based on the plurality of local dispersions.

9. The method of claim 7, wherein diffusing the reference histogram comprises quantizing the plurality of local dispersions to produce a plurality of quantized dispersions and convolving the reference histogram with a plurality of diffusion filters based on the plurality of quantized dispersions.

10. The method of claim 6, further comprising:
generating an estimated target image based on the reference image and the mapping; and
comparing the estimated target image to the target image to find differences between the target image and the estimated target image.

11. A non-transitory computer-readable medium comprising instructions that, when executed by a processor, cause the processor to:
generate a first mapping between a reference histogram for a reference image and a target histogram for a target image;
calculate a first diffused reference histogram based on the target histogram and the first mapping;
generate a second mapping between the first diffused reference histogram and the target histogram;
calculate a second diffused reference histogram based on the target histogram and the second mapping; and
generate a third mapping between the second diffused reference histogram and the target histogram.

12. The computer-readable medium of claim 11, wherein the first mapping maps between levels in one of the reference histogram and the target histogram and interstitial points in the other of the reference histogram and the target histogram.

13. The computer-readable medium of claim 11, wherein the instructions, when executed by the processor, cause the processor to:
generate an estimated target histogram based on the reference histogram and the first mapping;
determine a plurality of local dispersions of the target histogram relative to the estimated target histogram; and
calculate the first diffused reference histogram based on the plurality of local dispersions.

14. The computer-readable medium of claim 11, wherein the instructions, when executed by the processor, cause the processor to calculate the first diffused reference histogram by convolving the reference histogram with a diffusion filter and adding elements outside a domain of the reference histogram to elements inside the domain.

15. The computer-readable medium of claim 11, wherein the reference histogram is for a first color channel of the reference image, and wherein the instructions, when executed by the processor, cause the processor to generate a second color channel mapping between the reference histogram and the target histogram and a third color channel mapping between the reference histogram and the target histogram.
